(19) United States
(12) Patent Application Publication
(10) Pub. No.: US 2009/0206668 A1
(43) Pub. Date: Aug. 20, 2009

(54) UNINTERRUPTIBLE COOLING SYSTEM AND APPARATUS

(76) Inventor: Warwick Graham Andrew Dawes, Hong Kong (CN)

Correspondence Address: SWANSON & BRATSCHUN, L.L.C., 8210 SOUTHPARK TERRACE, LITTLETON, CO, 80120, US

(21) Appl. No.: 12/031,827

(22) Filed: Feb. 15, 2008

(51) Int. Cl. H02J 9/00

(52) U.S. Cl. 307/64

(57) ABSTRACT

A cooling system and power control apparatus provides an uninterruptible power supply. In one embodiment, the uninterruptible power supply provides power to an air conditioning system for cooling telecommunications equipment in the case of an AC power failure. Embodiments of the present invention include a first port configured for coupling with a primary power supply; a second port configured for coupling with a secondary power supply, wherein the secondary power supply is a backup power source that allows the cooling system to operate when the primary power supply exceeds predetermined operating conditions. A power circuit including a DC bus delivers power from the first port and the second port to a plurality of switches for controlling cooling equipment. A control circuit is configured to control power flow from the first port and power flow from the second port to the DC bus and the first plurality of switches.

### FIELD OF THE INVENTION

Embodiments of the present invention are directed to an uninterruptible cooling system and apparatus, and in particular, the cooling of equipment powered by an uninterruptible power supply.

### BACKGROUND OF THE INVENTION

It is general practice to provide backup power to critical equipment, such as telecommunications equipment, where a high level of availability is desired and an interruption in operation due to an AC (alternating current) supply failure is unacceptable. Telecommunications equipment is generally powered via a Telecom Rectifier which converts the AC mains input power to a DC (direct current) voltage suitable for powering the telecommunications equipment and for charging a backup battery. In the case of an AC mains supply failure, the battery continues to supply power to the telecommunications equipment without interruption for a period of time determined by the battery capacity.

Telecommunications equipment generates heat as a byproduct of operation. Telecommunication sites, such as mobile base transceiver stations, central offices, and mobile switching centers, are therefore typically equipped with cooling (air conditioning) systems to remove this heat and maintain the environment where the telecommunications equipment is installed at a suitable operating temperature.

A short interruption in the operation of the cooling system is normally not critical for the operation of the telecommunications equipment, but a longer interruption in the operation of the cooling system can result in the build-up of heat in the site and the resultant interruption in the operation of the critical telecommunications equipment due to excessively high temperatures. Measures are therefore taken to mitigate against a cooling system failure. These measures can include, for example: the provision of redundant cooling machines to guard against the failure of a single machine due to mechanical or electrical causes; the provision of diesel generators to provide AC backup to the air conditioners in the case of an AC mains failure; the provision of phase change materials in the site which prolongs the time taken for the temperature at the site to rise; or a combination of the above.

Many of these measures require the purchase of expensive, redundant equipment and provide an insufficient and/or inefficient solution. Accordingly, there is a need for a cooling system and apparatus that solves the shortcomings of existing systems.

### SUMMARY OF THE INVENTION

In accordance with one embodiment of the present invention, a cooling system including a compressor motor and a compressor operated by the compressor motor is disclosed. The cooling system further includes a first port configured for coupling with a primary power supply; a second port configured for coupling with a secondary power supply, wherein the secondary power supply is a backup power source that allows the cooling system to operate when the primary power supply exceeds predetermined operating conditions; a power circuit including a DC bus and a first plurality of switches, the DC bus coupled to the first port and the second port, the power circuit configured to deliver power from the first port and the second port to the DC bus and the first plurality of switches, wherein the first plurality of switches are configured to receive power from the DC bus and power the compressor motor; and at least one control circuit configured to control power flow from the first port and power flow from the second port to the DC bus and the first plurality of switches, the at least one control circuit configured to control the compressor motor.

In accordance with another embodiment of the present invention, a power control apparatus for delivering electrical power from a first power supply and a second power supply to an air conditioning system is disclosed. The power control apparatus includes a first input to receive power from the first power supply; a second input to receive power from the second power supply; a current shaping circuit coupled to the first port and the second port, the current shaping circuit having a DC bus; a plurality of switches coupled to the first port and the second port by the current shaping circuit, the plurality of switches configured to operate one or more cooling system devices; and a control circuit configured to monitor power received from the first input, the control circuit further configured to monitor power received from the second input and selectively deliver power from either the first input or the second input based on predetermined operating conditions.

In accordance with yet another embodiment of the present invention, a cooling system coupled to a first power supply and a second power supply is disclosed. The cooling system includes means for delivering power to cooling equipment; means for controlling a DC bus voltage; and means for monitoring an operating condition of the first power supply and monitoring an operating condition of the second power supply, wherein the means for delivering power to the cooling equipment delivers power from the first power supply during normal operation, and the means for delivery power to the cooling equipment delivers power from the second power supply when the operating condition of the first power supply exceeds predetermined operating parameters.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a block diagram showing a cooling system, in accordance with embodiments of the present invention.

FIG. 2 is a circuit diagram of a power circuit, in accordance with embodiments of the present invention.

FIG. 3 is a circuit block diagram of a first control circuit for use with the power control system, in accordance with embodiments of the present invention.

FIG. 4 is a circuit block diagram of a second control circuit for use with the power control system, in accordance with embodiments of the present invention.

FIG. 5 is a circuit block diagram of a third control circuit for use with the power control system, in accordance with embodiments of the present invention.

FIG. 6 is a circuit diagram of a power circuit, in accordance with an alternative embodiment of the present invention.

FIG. 7 is a circuit diagram of a power circuit, in accordance with an alternative embodiment of the present invention.

FIG. 8 is a circuit diagram of a power circuit, in accordance with an alternative embodiment of the present invention.

FIG. 9 is a circuit diagram of a power circuit, in accordance with an alternative embodiment of the present invention.

FIG. 10 is a circuit diagram of a power circuit, in accordance with an alternative embodiment of the present invention.

FIG. 11 is a circuit diagram of a power circuit, in accordance with an alternative embodiment of the present invention.

FIG. 12 is a flowchart diagram illustrating a power control system decision process, in accordance with an embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive.

Generally, embodiments of the present invention are directed to a cooling system and apparatus powered by an uninterruptible power supply. In one application, embodiments of the system and apparatus are used to cool equipment, such as telecommunications equipment or other critical equipment. However, embodiments of the present invention can also be extended to other applications requiring the use of uninterrupted cooling or air conditioning, such as for process applications and comfort cooling applications. Additionally, the various embodiments and implementations of an uninterruptible power supply system and apparatus, which are described as used for a cooling system, could also be used for other applications, other than cooling, where uninterruptible operation is required.

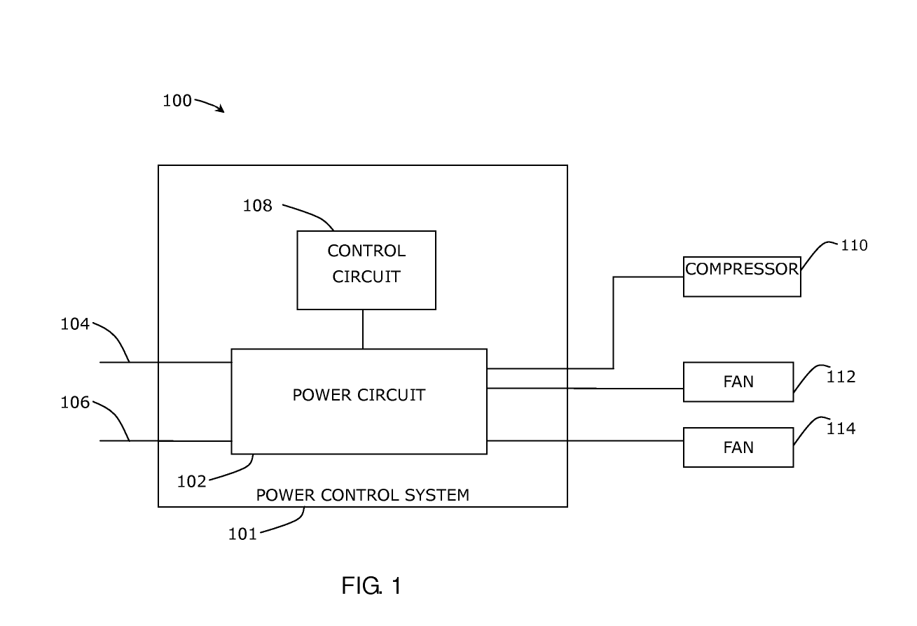

Referring now to the figures, FIG. 1 is a block diagram showing a cooling system 100, in accordance with embodiments of the present invention. The cooling system includes a power control system 101 and a power circuit 102 having a first port 104 that receives power from a primary power supply, typically AC power, and a second port 106 that receives power from a secondary power supply, such as DC power in the form of one or more batteries, or an alternative DC source such as a fuel cell, DC generator, or other power supply. The power circuit 102 receives power from the first port 104 during normal operation of the cooling system. In the case of an AC power failure, the power circuit 102 receives power from the second port 104.

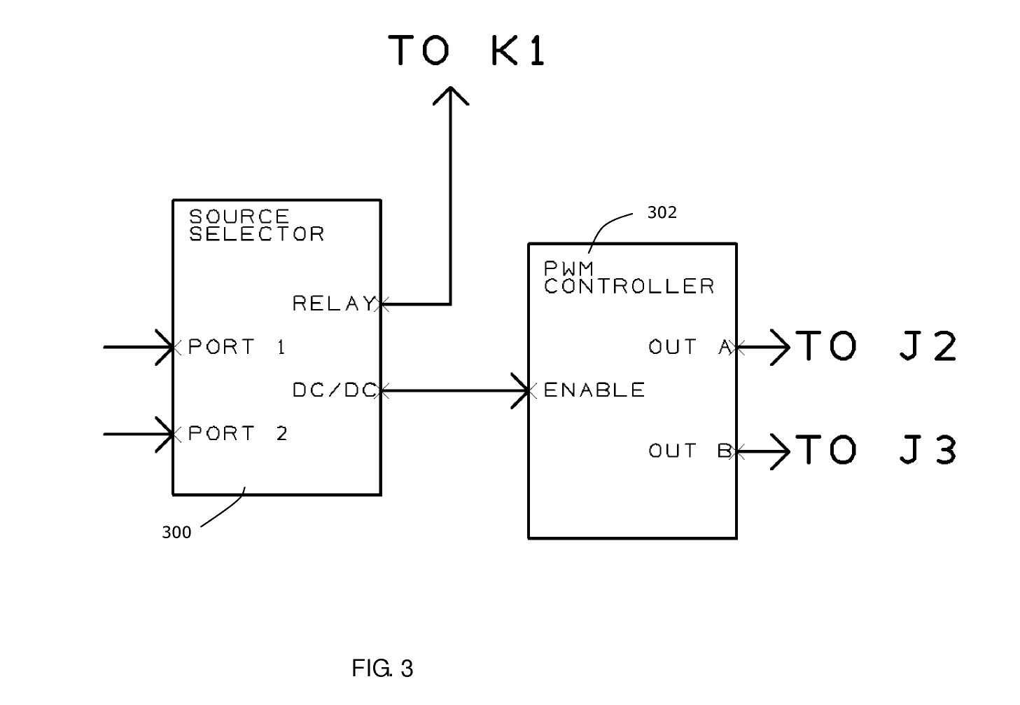

A control circuit 108 is operably coupled to the power circuit 102. The control circuit 108 operates in conjunction with the power circuit 102. The control circuit 108 may include a plurality of control circuits. For example, the functions performed by the control circuits illustrated and described with reference to FIGS. 3 to 5 may be incorporated into the control circuit 108. It will be appreciated that any number of required circuits may be incorporated separately or may be combined in to a single device, such as a microcontroller, microprocessor or other integrated circuit device.

The power circuit 102 is coupled to a compressor 110, an outdoor fan 112, and an indoor fan 114, each driven by a motor powered by the power circuit. The compressor 110, the outdoor fan 112, and the indoor fan 114 are typical components of an air conditioning system. However, it will be appreciated that the power control system 100 can be used to power any suitable air conditioning system, and the compressor 110, the outdoor fan 112, and the indoor fan 114 are included to illustrate example components of an air conditioning system.

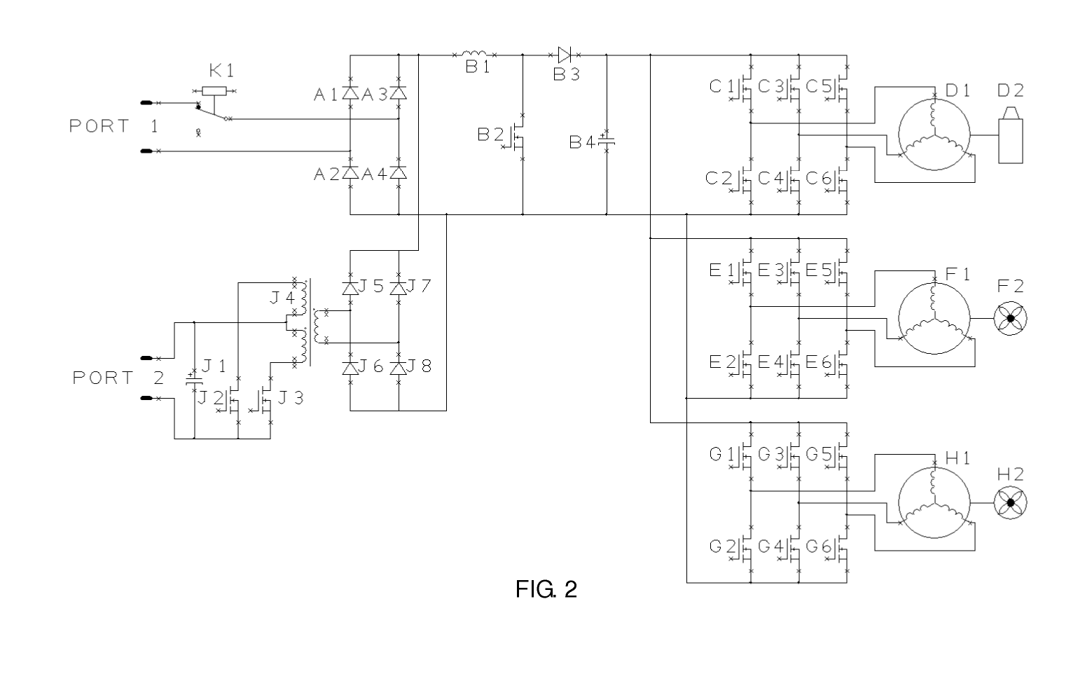

FIG. 2 is a circuit diagram of the power circuit, in accordance with embodiments of the present invention. The power circuit is operably coupled to an air conditioning system comprising a plurality of motors (D1, F1, H1), a compressor D2, an outdoor fan F2 and an indoor fan H2. The power circuit includes two input power supply ports, Port 1 and Port 2. Port 1, to which AC mains is connected, is the primary source of power. Port 2, to which DC backup power is connected, is the secondary source of power.

Power is drawn from Port 1 when the AC mains supply is within specified operating conditions. Power is drawn from Port 2 when the AC mains supply is not within specified operating conditions and the DC backup supply is within specified operating conditions. A first control circuit detects the conditions of Port 1 and Port 2 and the control circuit selects operation from Port 1 or Port 2 by controlling relay K1 and semiconductor switches J2 and J3 accordingly based on the detected conditions. An example first control circuit for performing this detection and control is described with reference to FIG. 3.

An input rectification circuit comprises diodes A1, A2, A3 and A4, which converts the sinusoidal AC input voltage to rectified sinusoidal DC voltage when relay K1 is closed. A push-pull DC/DC converter circuit comprises capacitor J1, semiconductor switches J2 and J3, transformer J4 and diodes J5, J6, J7, J8, which converts the voltage at Port 2 to a level suitable for input to a boost input current shaping circuit, and provides galvanic isolation from the AC mains, which may be required at Port 2.

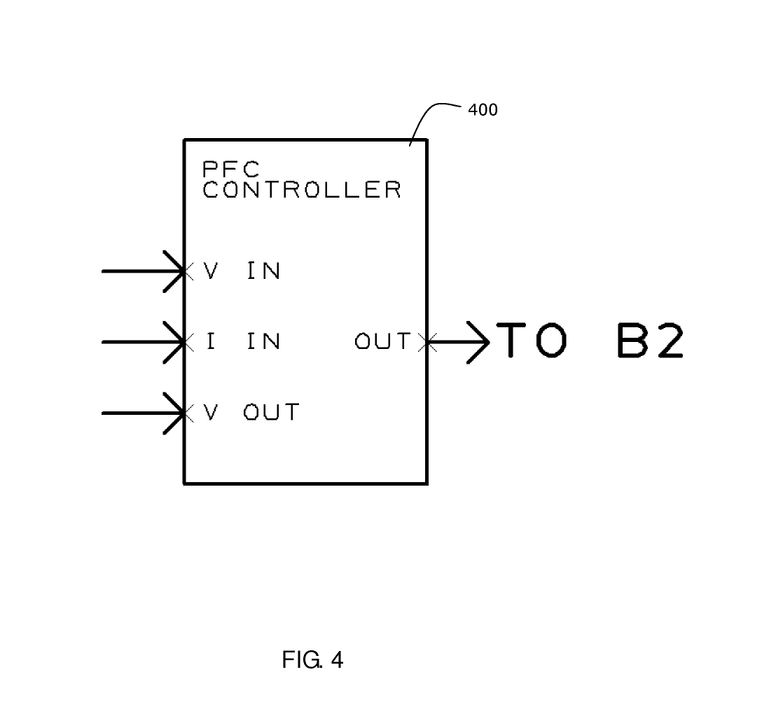

Other suitable configurations of a different topology DC/DC converter stage may be used such as, for example, half bridge, full bridge, forward, and any other suitable configurations. The input current shaping circuit, comprises inductor B1, semiconductor switch B2, diode B3 and capacitor B4. A second control circuit controls semiconductor switch B2 such that the input current THD is reduced when operating from the AC Mains (Port 1) while controlling the output voltage across capacitor B4 to the desired level. In the illustrated embodiments, capacitor B4 is the DC bus. An example of the second control circuit for performing this detection and control function is further described with reference to FIG. 4. One suitable control circuit is a boost power factor correction (PFC) circuit, which maintains input current proportional to input voltage.

The second control circuit may also control semiconductor switch B2 such that the low frequency input current is reduced when operating from the DC backup (Port 2) while controlling the output voltage across capacitor B4 (DC bus) to the desired level. The boost power factor correction (PFC) circuit, which maintains input current proportional to input voltage, is also one suitable control circuit for this purpose.

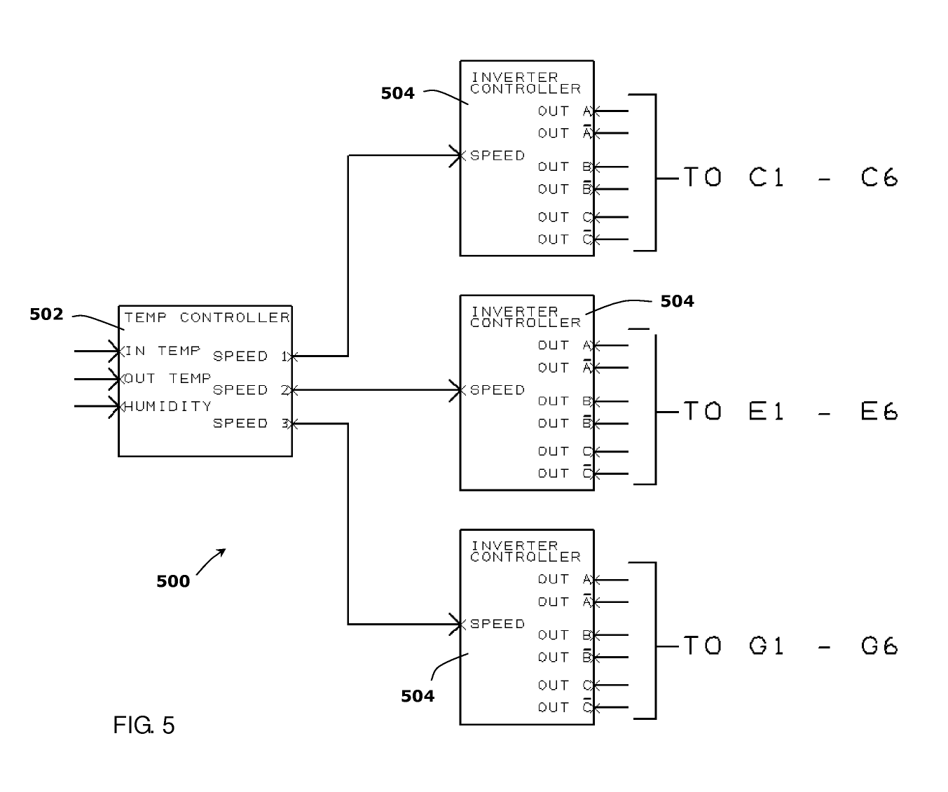

A DC/AC inverter comprises semiconductor switches C1 to C6, which is suitable for driving an air conditioner compressor motor D1. In one embodiment, the air conditioner compressor D2 is driven by an AC motor or DC brushless motor D1. However, any suitable motor may be used. A third control circuit controls semiconductor switches C1 to C6 such that the voltage and frequency applied controls the speed of the motor, and hence capacity of the compressor to the desired level. An example control circuit for performing this control function is further described with reference to FIG. 5.

A DC/AC inverter comprising semiconductor switches E1 to E6 powers an outdoor fan motor F1. An outdoor fan F2 is driven by the outdoor fan motor F1, which may be an AC motor or DC brushless motor F1. The third control circuit controls semiconductor switches E1 to E6 such that the voltage and frequency applied controls the speed of the outdoor fan motor F1 to the desired level.

A DC/AC inverter consisting of semiconductor switches G1 to G6 powers an indoor fan motor H1. The indoor fan H2 is driven by the indoor fan motor H1, which may be an AC motor or DC brushless motor H1. The third control circuit controls semiconductor switches G1 to G6 such that the voltage and frequency applied control the speed of the indoor fan H2 to the desired level.

The illustrated motors D1, F1, and H1 are shown as three-phase motors. However, other suitable motors may be used, such as two-phase motors or other suitable motors, together with corresponding DC/AC inverter circuits. Also, while the illustrated embodiment includes the outdoor fan motor F1 to drive the outdoor fan F2 and the indoor fan motor H1 to drive the indoor fan H2, embodiments of the present invention can use one fan motor to drive both the outdoor fan F2 and the indoor fan H2. Accordingly, it will be known to a person skilled in the art that one or more motors may be used to drive any number of fans in a cooling system.

It should be noted that relay K1 is not required for all cases and is dependent on the criteria used to select operation from Port 1 or Port 2. It is, for example, not required when the peak voltage applied at Port 1 does not exceed the output voltage of the DC/DC converter circuit coupled to Port 2 when operation from Port 2 is desired. Omission or inclusion of relay K1 does not necessarily change the fundamental operation of this embodiment.

FIG. 3 is a circuit block diagram of a first control circuit 300 for use with the power control system, in accordance with embodiments of the present invention. The first control circuit to detect the conditions of Port 1 and Port 2 and to control relay K1 and semiconductor switches J2 and J3, and the control circuit selects operation from Port 1 or Port 2 accordingly based on the detected conditions of Port 1 and Port 2. In the illustrated embodiment, the first control circuit includes a source selector 300 that receives input from Port 1 and Port 2 and provides outputs to control relay K1 and to activate/deactivate pulse width modulation (PWM) controller 302. When Port 1 is selected, AC power is delivered via control relay K1. When Port 2 is selected, the main function of PWM controller 302 is to provide alternating control signals to the switches of the DC/DC converter circuit to convert the DC supply from Port 2 to AC for voltage transformation and galvanic isolation via a transformer. For some embodiments of the invention, the PWM controller may also control the pulse width of the switches of the DC/DC converter circuit to adjust the average voltage applied and hence output voltage and/or input and output current of the DC/DC converter circuit.

FIG. 4 is a circuit block diagram of a second control circuit 400 for use with the power control system, in accordance with embodiments of the present invention. The second control circuit 400 controls semiconductor switch B2 such that the input current THD is reduced when operating from the AC mains (Port 1), while the output voltage across capacitor B4 is controlled to the desired level. The illustrated embodiment of the second control circuit is a boost power factor correction (PFC) controller 400, which maintains input current proportional to input voltage, according to the proportion required for the operation of the cooling system. This same control circuit 400 may also control semiconductor switch B2 such that the low frequency input ripple current is reduced when operating from the DC Backup (Port 2), while the output voltage across capacitor B4 is controlled to the desired level.

FIG. 5 is a circuit block diagram of a third control circuit 500 for use with the power control system, in accordance with embodiments of the present invention. In the illustrated embodiment, the third control circuit 500 is suitable for determining the desired speed for the compressor, the speed of the indoor fan, and the speed of the outdoor fan based on predetermined factors, including, for example, the indoor temperature, the outdoor temperature and indoor humidity. The third control circuit 500 includes a temperature controller 502 and a plurality of inverter controllers 504. The temperature controller inputs include the inside temperature, the outside temperature, and the humidity. The speeds are determined based on these inputs and output to the inverter controllers 504. Each of the output speeds need not be the same and may be independently determined depending on the requirements each of the powered devices. Generally, the number of inverter controllers 504 corresponds to the number of devices being controlled. In the illustrated embodiment, three inverter controllers 504 are included corresponding to the compressor, the outdoor fan, and the indoor fan.

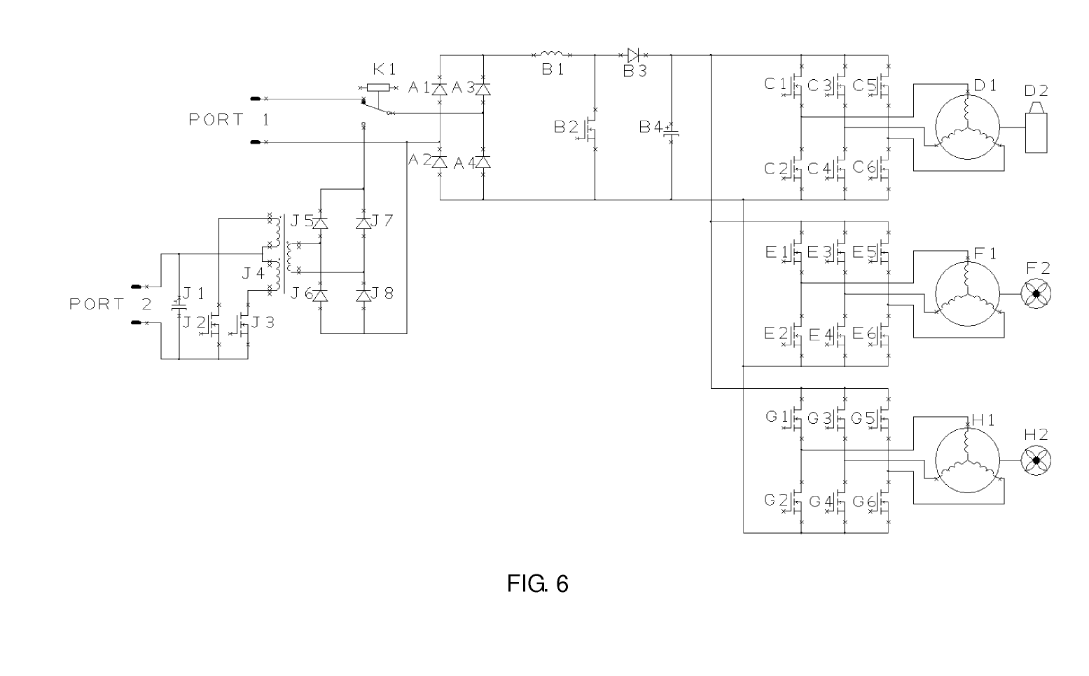

FIG. 6 is a circuit diagram of a power circuit, in accordance with an alternative embodiment of the present invention. The alternative embodiment of the power circuit shown in FIG. 6 operates similarly to the embodiment shown and described with reference to FIG. 2. The various control circuits and components of the air conditioning system are similarly incorporated in each of the alternative embodiments of the power circuit as described with reference to FIG. 2.

In the alternative embodiment illustrated in FIG. 6, relay K1 is connected as a changeover relay, such that operation from Port 1 or Port 2 can be selected depending on which pole of the relay is operated. A control circuit detects the conditions of Port 1 and Port 2 and controls relay K1 to select operation from either Port 1 or Port 2 accordingly, depending on the detected conditions. The output of the DC/DC converter, J1 to J8, is connected before the AC input rectification circuit, diodes A1 to A4, via changeover relay K1.

The embodiment shown in FIG. 6 provides similar performance to the preferred embodiment in FIG. 2, except that there may be additional losses in rectifier diodes A1 to A4 in FIG. 6 during operation from Port 2.

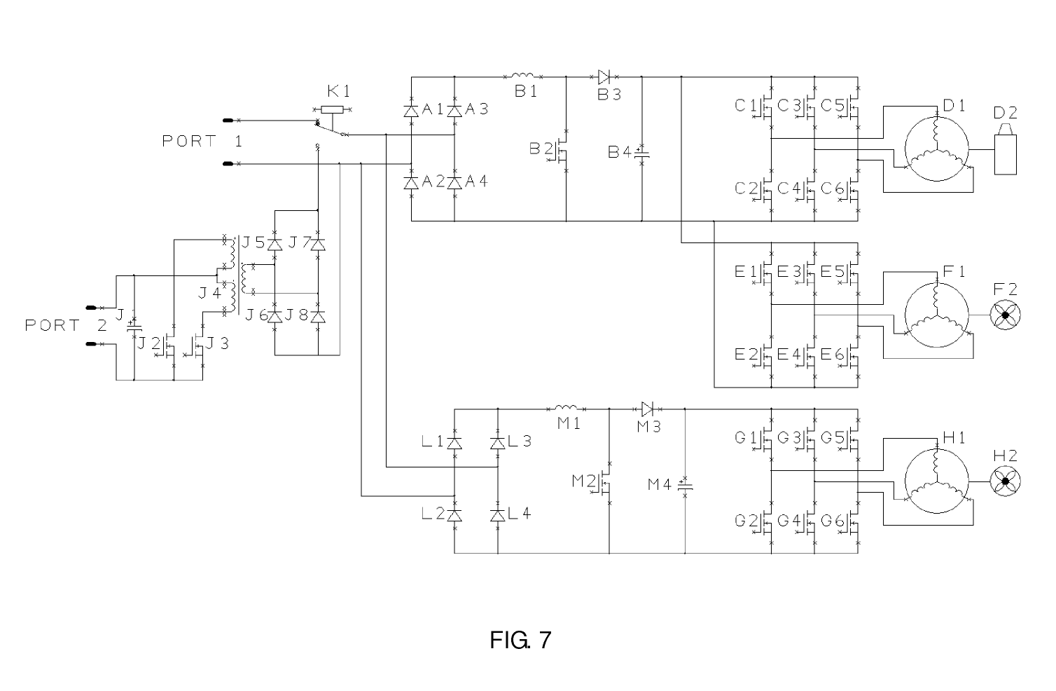

FIG. 7 is a circuit diagram of the power circuit, in accordance with an alternative embodiment of the present invention. The alternative embodiment of the power circuit shown in FIG. 7 operates similarly to the embodiment shown and described with reference to FIG. 6.

In the alternative embodiment illustrated in FIG. 7, power to the indoor fan motor H1 is supplied via independent rectification and input. The independent rectification and input is provided by an input rectification circuit including diodes L1 to L4 (AC to DC converter). An independent current shaping circuit including M1 to M4 is also included. Similar to the embodiment shown in FIG. 6, the embodiment illustrated in FIG. 7 may also have additional losses in rectifier diodes A1 to A4 during operation from Port 2. The embodiment illustrated in FIG. 7 also requires additional components of components L1 to L4 and M1 to M4, which are not required in the embodiments illustrated in FIGS. 2 and 6, and associated control circuitry.

The embodiment illustrated in FIG. 7 includes two independent channels such that the circuitry of each channel may be physically separated from each other. Each independent channel is coupled to both Port 1 and Port 2 via the control relay K1. The first channel includes input rectification circuitry of A1 to A4, current shaping circuitry including B1 to B4, a first switch C1 to C6 to control the motor D1, and a second switch E1 to E6 to control motor F1. The second channel includes input rectification circuitry of L1 to L4, current shaping circuitry including M1 to M4, and a third switch G1 to G6 to control the motor H1. Similarly, any number of independent channels may be incorporated with embodiments of the present invention. Additionally, any number of switches may be incorporated and controlled by each channel to support any desired number of cooling system devices.

The embodiment of FIG. 7 has a further advantage in that the input supply for the indoor fan H2 is separated from the input supply for the outdoor fan F2 and compressor D2, which can allow for implementation in a split air conditioning configuration where the outdoor fan F2 and compressor D2 are physically separate from the indoor fan. It also facilitates the use of packaged electronically commutated (EC) fans, which can operate on both AC and DC.

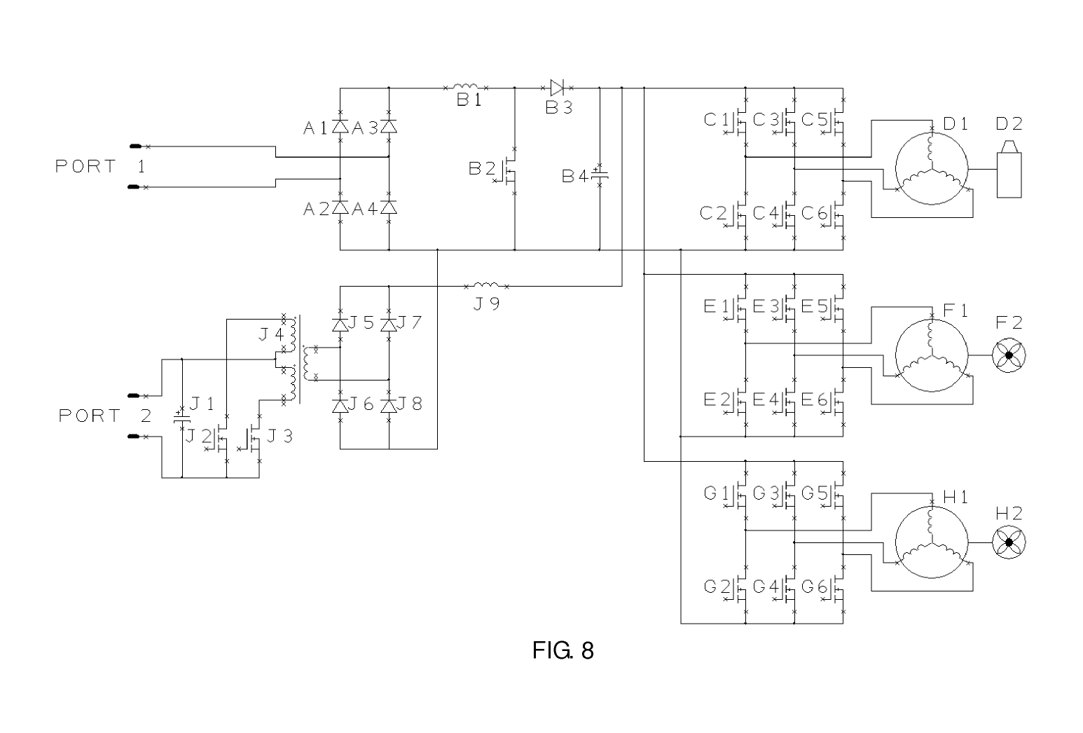

FIG. 8 is a circuit diagram of the power circuit, in accordance with an alternative embodiment of the present invention. The embodiment illustrated in FIG. 8 operates similarly to the embodiment illustrated in FIG. 2, but includes an additional inductor J9 in the output of the DC/DC converter circuit (J1 to J9). The output of the DC/DC converter circuit is connected across the output of the input current shaping circuit (B1 to B4), instead of the input to the input current shaping circuit. In many cases, and as illustrated in the embodiment of FIG. 8, relay K1 can be omitted in this configuration. The various control circuits and components of the air conditioning system are similarly incorporated as described with reference to FIG. 2

The embodiment in FIG. 8 has the advantage that a controlled amount of power can be drawn from both Port 1 and Port 2 simultaneously, without one port causing disturbances at the other port. This can be beneficial in cases when the amount of power from either port is limited for some reason, such as the cooling system being powered from a small capacity diesel generator, for example. In this embodiment a control circuit controls DC/DC semiconductor switches J2 and J3 and input current shaping circuit's semiconductor switch B2 to control the amount of power delivered from each of the supply ports.

However, connection in this way precludes the input current shaping circuit (B1 to B4) from controlling the voltage across capacitor B4 to the desired level, or from controlling the low frequency input ripple current (distortion), when operating from Port 2. It is, however, possible for the DC/DC converter circuit to act as an input current shaping circuit and control the low frequency input ripple current and the voltage across capacitor B4, but with additional requirements on control circuitry. Also, operation at reduced pulse widths increases high frequency ripple currents at Port 2, necessitating greater filtering.

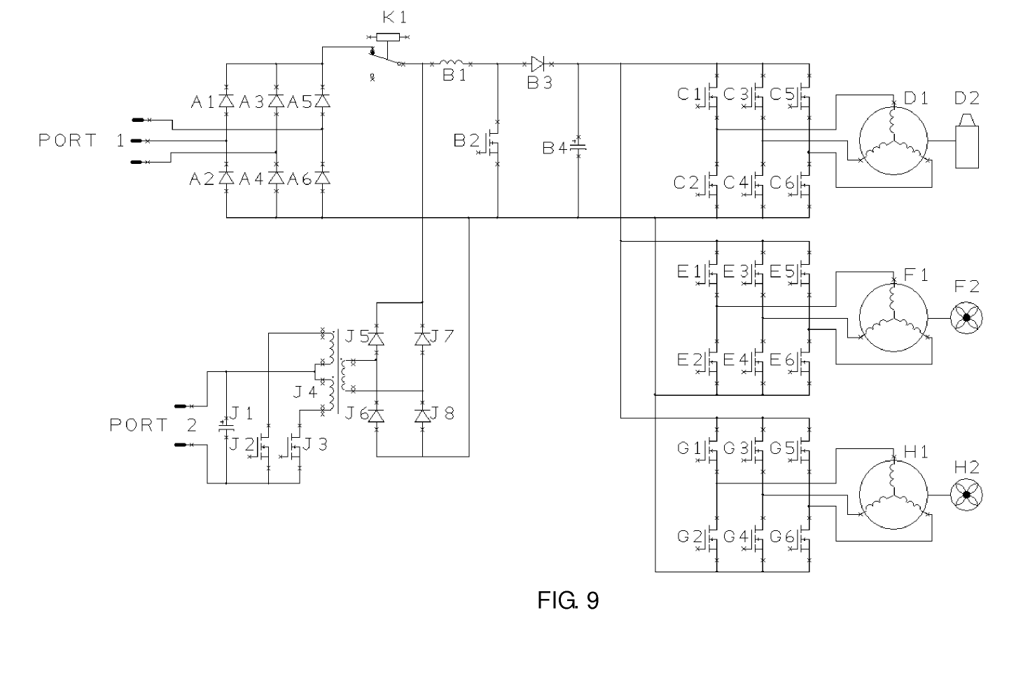

FIG. 9 is a circuit diagram of the power circuit, in accordance with an alternative embodiment of the present invention. The embodiment illustrated in FIG. 9 operates similarly to the embodiment illustrated in FIG. 2, but includes two additional diodes A5 and A6 which allow Port 1 to be connected to a three phase AC supply. This embodiment could be used, for example, where the power consumed by the cooling system exceeds the level readily supplied by a single phase supply, or in other cases where operation from a three phase supply is desired. In this illustration the relay K1 has been placed after the rectification diodes A1 to A6, but multiple relays or multipole relays could be utilized to disconnect each AC line before rectification diodes A1 to A6 if desired. Similarly, as described in the case for FIG. 2., the relay K1 can be omitted in some cases without fundamentally changing the operation of the embodiment.

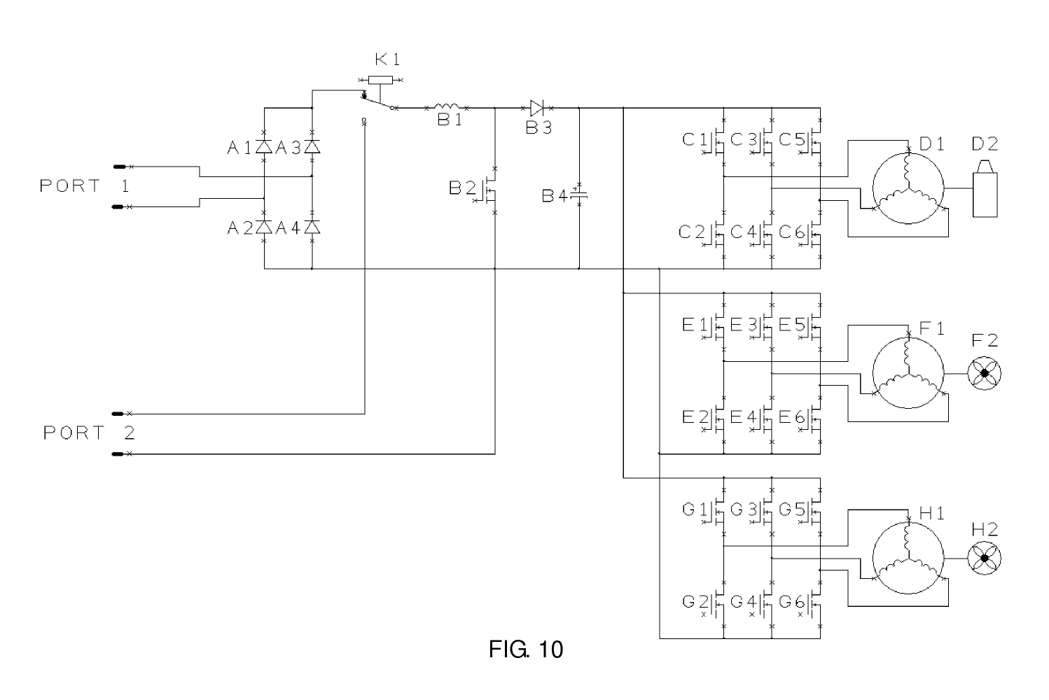

FIG. 10 is a circuit diagram of the power circuit, in accordance with an alternative embodiment of the present invention. The embodiment illustrated in FIG. 10 operates similarly to the embodiment illustrated in FIG. 2, together with associated control circuits, but excludes the DC/DC converter circuit components J1 to J8 and associated PWM control controller circuit 302 (shown in FIG. 3). Also, in this embodiment, relay K1 is positioned after the rectification diodes A1 to A4 and is configured as a changeover relay. This embodiment could be used, for example, for cases where the voltage of the DC backup supply to Port 2 is compatible with the level required for the input to the current shaping circuit B1 to B4 and galvanic isolation is not required for Port 2.

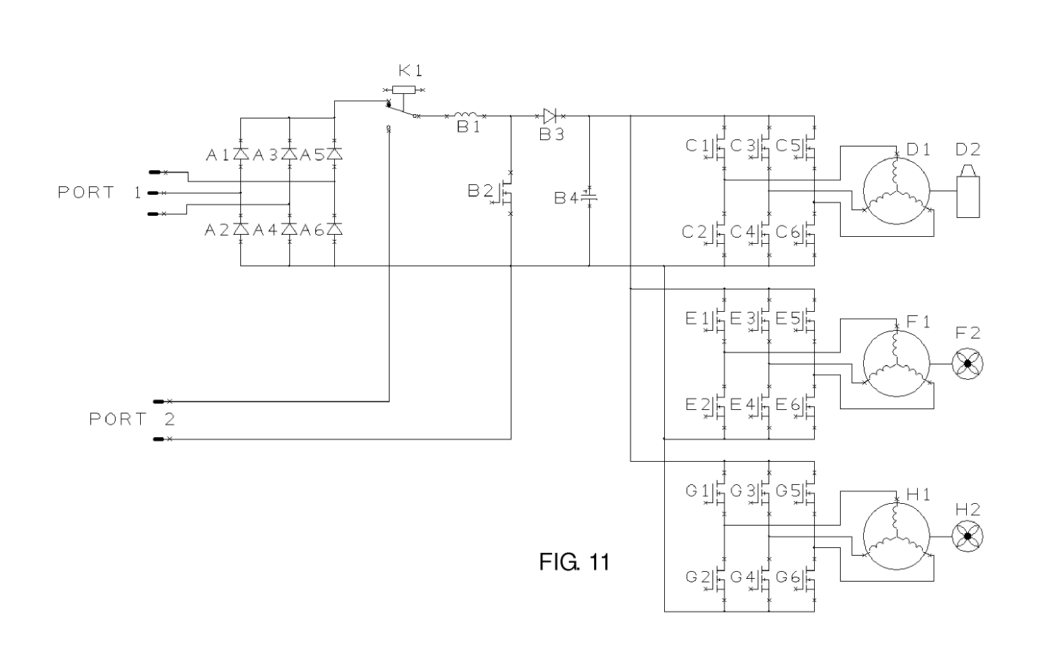

FIG. 11 is a circuit diagram of the power circuit, in accordance with an alternative embodiment of the present invention. The embodiment illustrated in FIG. 11 operates similarly to the embodiment illustrated in FIG. 10, together with associated control circuits, but includes two additional rectification diodes A5 and A6 to allow operation from a three phase AC supply to Port 1.

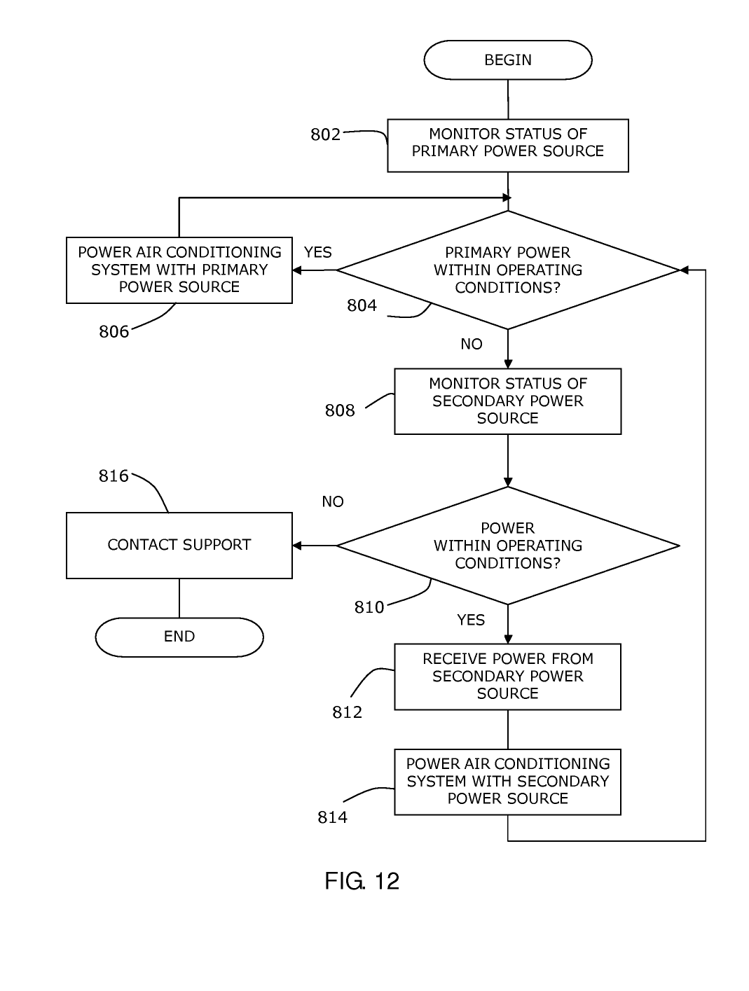

FIG. 12 is a flowchart diagram illustrating a power control decision process, in accordance with an embodiment of the present invention. In step 802, the power control system monitors the status of the primary power source, which is the AC power received through Port 1. In step 804, the system determines whether the primary power source is within the required operating conditions. If yes, then the air conditioning system is powered with the primary power source, 806. If no, the system monitors the status of the secondary power source, which is the DC power received through Port 2, 808. The primary power source being outside of the operating conditions is typically indicative of an AC power failure. While the air conditioning system is being powered by the primary power source, the system will return to step 804 to check if the primary power source is within the operating conditions. In step 810, the system determines whether the secondary power source is within the required operating conditions. If yes, then power is received from the secondary power source 812 and the air conditioning system is powered by the secondary power source. While the air conditioning system is being powered by the secondary power source, the system will return to step 804 to check if the primary power source is within the operating conditions, which would signal a restoration of the AC power source. If the AC power source has not been restored, then power by the secondary power source continues. If the AC power source has been restored, then the system proceeds to step 806. If the secondary power source is not within the required operating conditions, which may be an indication that the secondary power source has been depleted, then a central operations center may be alerted so that a physical inspection of the site may be made 816

It will be appreciated by those skilled in the art that the various circuits, switches, components, power supplies, and devices are coupled as described above such that they are in operable communication with each other, either directly or indirectly, as required by the specific implementation of embodiments of the invention.

The terms “uninterruptible” and “uninterruptible power supply” as used throughout this description are known in the field and the meaning of these terms will be appreciated by those skilled in the field. It will be appreciated that the term “uninterruptible” describes the presence of redundancy in case of any disruption or interruption in the delivery of primary power (typically AC mains) to the powered device. It should be appreciated that applications of the present invention (including the field of the invention herein described) may in some cases permit or even desire a temporary interruption in cooling operation within acceptable limits. “Uninterruptible” as used in this description, therefore, means the ability to continue to operate without interruption, or to operate following a temporary interruption, from a secondary power source in the case of any disruption or interruption in delivery of the primary power supply.

It will also be appreciated that the one or more control circuits use uninterruptible power in order to operate in conjunction with the uninterruptible cooling system. Accordingly, for example, the one or more control circuits are alternately powered by either the primary power supply or the secondary power supply, similar to the delivery of power to the components of the cooling system. Also, other redundant methods of ensuring the delivery of power to the one or more control circuits may be used, such as separate or additional batteries or back-up power supplies.

While the invention has been particularly shown and described with reference to the illustrated embodiments, those skilled in the art will understand that changes in form and detail may be made without departing from the spirit and scope of the invention. For example, while the embodiments of the present invention are described and illustrated with circuit diagrams, it will be appreciated that the invention may be implemented using integrated circuits, programmable logic devices, computer software, or a combination of any suitable implementations.

What is claimed is:

1. A cooling system including a compressor motor and a compressor operated by the compressor motor, the cooling system comprising:
a first port configured for coupling with a primary power supply;
a second port configured for coupling with a secondary power supply, wherein the secondary power supply is a backup power source that allows the cooling system to operate when the primary power supply exceeds predetermined operating conditions;
a power circuit including a DC bus and a first plurality of switches, the DC bus coupled to the first port and the second port, the power circuit configured to deliver power from the first port and the second port to the DC bus and the first plurality of switches, wherein the first plurality of switches are configured to receive power from the DC bus and power the compressor motor; and
at least one control circuit configured to control power flow from the first port and power flow from the second port to the DC bus and the first plurality of switches, the at least one control circuit configured to control the compressor motor.

2. The cooling system of claim 1, wherein the power circuit includes an input current shaping circuit to reduce input current distortion and control a DC bus voltage.

3. The cooling system of claim 2, wherein the power circuit further includes a converter coupled to the second port to receive power from the secondary power supply and output power having a predetermined voltage level.

4. The cooling system of claim 3, wherein the converter further provides galvanic isolation.

5. The cooling system of claim 3, wherein the power circuit further includes a changeover relay that alternately connects to the first port and the second port, wherein the changeover relay connects to the first port when the cooling system operates from the primary power supply and the changeover relay connects to the output of the converter when the cooling system operates from the secondary power supply.

6. The cooling system of claim 2, wherein the input current shaping circuit is a boost power factor correction circuit.

7. The cooling system of claim 1, further comprising at least one fan motor coupled to a second plurality of switches, and the at least one control circuit is further configured to selectively deliver power to the at least one fan motor from the first port or the second port; and wherein the at least one control circuit is further configured to control the second plurality of switches such that the at least one fan motor rotation is controlled; and wherein the at least one control circuit receives uninterrupted power from the first port or the second port.

8. The cooling system of claim 1, wherein the at least one control circuit includes a source selector circuit to select operation of the cooling system from the first port or the second port based on operating conditions of the first port and the second port.

9. The cooling system of claim 1, wherein the at least one control circuit includes a circuit to adjust the speed of the compressor motor and the capacity of the compressor to control the temperature of the environment to be cooled.

10. The cooling system of claim 1, wherein the power circuit further includes a relay to disconnect the flow of power from the first port when operating from the second port.

11. The cooling system of claim 1, the power circuit further including a plurality of diodes coupled to the first port to provide voltage rectification of power received from the primary power supply.

12. The cooling system of claim 11, wherein the plurality of diodes are configured to allow power received from the first port to be single phase AC or multiple phase AC.

13. The cooling system of claim 11, wherein the power circuit further includes a converter circuit and a changeover relay that alternately connects to the output of the plurality of diodes and the output of the converter circuit, wherein the changeover relay connects to the output of the plurality of diodes when the cooling system operates from the primary power supply and the changeover relay connects to the output of the converter circuit when the cooling system operates from the secondary power supply, and wherein the converter circuit is a push-pull DC converter configured to adjust a DC voltage level.

14. The cooling system of claim 2, wherein the power circuit further includes a second input current shaping circuit coupled to the first port and the second port, the second input current shaping circuit including a second DC bus to power a second plurality of switches.

15. A power control apparatus for delivering electrical power from a first power supply and a second power supply to an air conditioning system, the power control apparatus comprising:
a first input to receive power from the first power supply;
a second input to receive power from the second power supply;
a current shaping circuit coupled to the first port and the second port, the current shaping circuit having a DC bus;
a plurality of switches coupled to the first port and the second port by the current shaping circuit, the plurality of switches configured to operate one or more cooling system devices; and
a control circuit configured to monitor power received from the first input, the control circuit further configured to monitor power received from the second input and selectively deliver power from either the first input or the second input based on predetermined operating conditions.

16. The power control apparatus of claim 15, further comprising a control relay coupled to the first input to stop the delivery of power from the first input when power from the first input exceeds predetermined operating conditions.

17. The power control apparatus of claim 16, wherein the control relay is a changeover relay, the control relay further coupled to the second input, wherein the control relay can alternately receive power from the first input or the second input, and wherein control circuit is configured to receive power from the second input when power from the first input exceeds predetermined operating conditions.

18. The power control apparatus of claim 17, further comprising a second current shaping circuit coupled to the first port and the second port, the current shaping circuit having a second DC bus.

19. A cooling system coupled to a first power supply and a second power supply, the cooling system comprising:
means for delivering power to cooling equipment;
means for controlling a DC bus voltage; and
means for monitoring an operating condition of the first power supply and monitoring an operating condition of the second power supply, wherein the means for delivering power to the cooling equipment delivers power from the first power supply during normal operation, and the means for delivery power to the cooling equipment delivers power from the second power supply when the operating condition of the first power supply exceeds predetermined operating parameters.

20. The cooling system of claim 19, further comprising means for selectively receiving power from the first power supply or the second power supply.
